(19) United States
(12) Patent Application Publication
(10) Pub. No.: US 2025/0359517 A1
(43) Pub. Date: Nov. 27, 2025

(54) PLANTING POT WITH CAPILLARY WATERING SYSTEM

(71) Applicant: NuVue Products Ltd., Toronto (CA)

(72) Inventor: William Trent Coleman, Woodbridge (CA)

(21) Appl. No.: 18/671,398

(22) Filed: May 22, 2024

(51) Int. Cl. A01G 9/02; A01G 27/06

(52) U.S. Cl. CPC A01G 9/028; A01G 27/06

(57) ABSTRACT

A planting pot including: a) a container including a base and a wall extending upwardly from the base defining an interior region of the planting pot and b) a plant watering assembly. The plant watering assembly includes: a support pedestal disposed within the planting pot interior region and dividing the interior region into a lower water reservoir and an upper soil retaining region, a plurality of wick holders each including a casing defining a central through bore, and a plurality of water transferring wicks, each received in the central through bore of a respective one of the plurality of wick holders. The support pedestal divides the interior region into a lower water reservoir and an upper soil retaining region and includes a body having a circumferential rim engaging the container wall and a central boss extending downwardly from the body and contacting the base of the planting pot.

### TECHNICAL FIELD

The present disclosure relates to a planting pot or planting pot device including a capillary watering system or assembly and, more specifically, to a planting pot including a container having base and a wall extending upwardly from the base, the base and the wall defining an interior region of the planting pot, and a plant watering assembly including a support pedestal disposed within the planting pot interior region and dividing the planting pot interior region into a lower water reservoir and an upper soil retaining region, a plurality of wick holders each including a casing defining a central through bore, and a plurality of water transferring wicks, each received in the central through bore of a respective one of the plurality of wick holders.

### BACKGROUND

Planting pots are widely used for starting plants from seeds and/or transplanting seedlings or established or plants. If the plant is being grown in an indoor location where natural precipitation is not available, providing proper soil hydration to newly planted or transplanted plants or seedlings may be problematic, especially for inexperienced gardeners. Both overhydration and dehydration may result in poor results, especially for newly transplanted plants or young plants grown from seed that do not have a fully developed root system or that have experienced transplant shock. Further, to the extent the gardener is away from the planting pot for an extended period of time, for example, on an extended vacation, providing sufficient water to the plant may be a problem.

To address this issue, planting pots having capillary watering systems, sometimes referred to as self-watering systems, are known. For example, U.S. Pat. No. 11,197,456 to Cole discloses a planting watering device or planting pot having a plurality of water transporting wicks that, via capillary action, transport water from a water reservoir at the base of the device or pot upwardly into planting soil or other planting medium disposed above the water reservoir. While the wicks extend into the soil, water from the reservoir may not travel upwardly through the soil in sufficient quantity to properly hydrate a plant with shallow roots which, of course, would be planted at or near the upper surface of the soil in the planting pot. That is, the soil in the vicinity of the plants shallow roots which is near the top of soil or growing medium of the planting pot may not be sufficiently moist. Because the wicks are not supported or positioned in a vertical or upward orientation within the soil and, further, because the wicks are in direct contact with the soil, the effective upward capillary force may be reduced such that the transported water tends to leach out of the wick at a lower position in the planning pot. That is, it may be the case that while the soil nearer the water reservoir in the base is moist, the soil near the top of the planting pot adjacent the shallow plant roots is much drier. Lacking proper hydration, the new or transplanted plant may die or experience stunted growth.

What is needed is a planting pot with an improved capillary watering system or assembly that provides a sufficient volume of water to properly moisten soil near the top of the planting pot, in the vicinity of a new plant's shallow root system.

### SUMMARY

In one aspect, the present disclosure relates to a planting pot comprising: a) a container including a base and a wall extending upwardly from the base, the base and wall defining an interior region of the planting pot; and b) a plant watering assembly including: 1) a support pedestal disposed within the interior region of the planting pot, the support pedestal dividing the interior region of the planting pot into a lower water reservoir and an upper soil retaining region, the support pedestal including a body having a circumferential rim engaging an inner surface of the wall of the container, the body of the support pedestal further including a plurality of openings; 2) a plurality of wick holders, each wick holder of the plurality of wick holders defining a central through bore and including a base portion received in an opening of the plurality of openings of the body of the support pedestal and an upwardly extending projection that extends into the upper soil retaining region of the planting pot, the upwardly extending projection including a plurality of orifices; and 3) a plurality of water transferring wicks, each wick of the plurality of water transferring wicks received in the central through bore of a respective one of the plurality of wick holders, a lower end portion of each of the plurality of water transferring wicks extending into the lower water reservoir of the planting pot and an upper end portion of each of the plurality of water transferring wick extending into the upper soil retaining region of the planting pot, the plurality of orifices of each wick holder of the plurality of wick holders permitting water flow from the respective wicks of the plurality of water transferring wicks into the upper soil retaining region of the planting pot.

In another aspect, the present disclosure relates to a planting pot device comprising the present disclosure relates to planting pot device comprising: a) a planting pot including a base and a wall extending upwardly from the base, the base and wall defining an interior region of the planting pot; and b) a plant watering assembly including: 1) a support pedestal disposed within the interior region of the planting pot, the support pedestal dividing the interior region into a lower water reservoir and an upper soil retaining region, the support pedestal including a body having a circumferential rim engaging the wall of the planting pot, the body of the support pedestal further including a plurality of openings; 2) a plurality of wick holders, each wick holder of the plurality of wick holders having a central through bore and including a base portion received in an opening of the plurality of openings of the body of the support pedestal and an upwardly extending projection that extends into the upper soil retaining region of the planting pot, the upwardly extending projection including a plurality orifices; and 3) a plurality of water transferring wicks, each wick of the plurality of water transferring wicks received in the central through bore of a respective one of the plurality of wick holders, a lower end portion of each of the plurality of water transferring wicks extending into the lower water reservoir of the planting pot and an upper end portion of each of the plurality of water transferring wicks extending into the upper soil retaining region of the planting pot.

### BRIEF DESCRIPTION OF THE DRAWINGS

The foregoing and other features and advantages of the present disclosure will become apparent to one skilled in the art to which the present disclosure relates upon consideration of the following description of the disclosure with reference to the accompanying drawings, wherein like reference numerals, unless otherwise described refer to like parts throughout the drawings and in which:

FIG. 1 is a schematic front perspective view of a first example embodiment of a planting pot with a plant watering assembly including a container and the plant watering system disposed in the container;

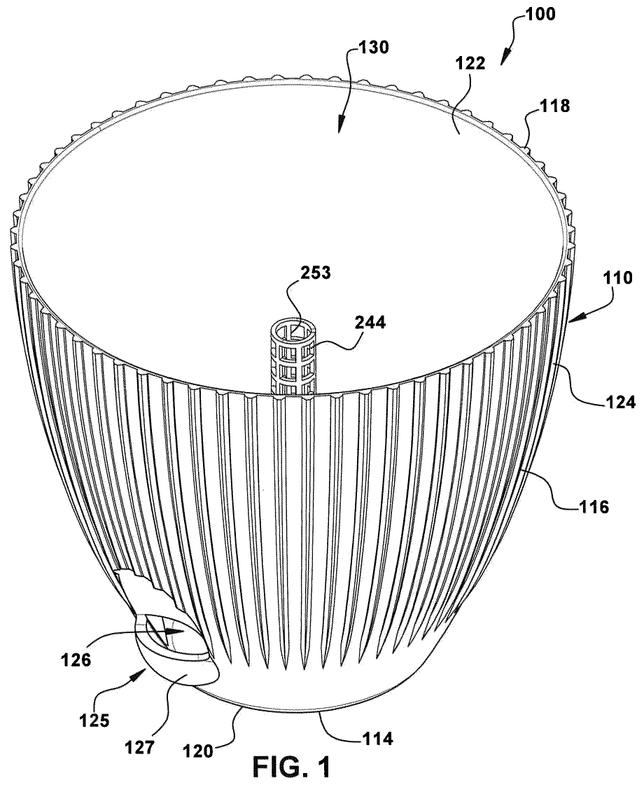

FIG. 2 is a schematic front elevation view of the planting pot of FIG. 1;

FIG. 3 is a schematic top perspective view of the planting pot of FIG. 1;

FIG. 4 is a schematic exploded top perspective view of the planting pot of FIG. 1;

FIG. 5 is a vertical section view of the planting pot of FIG. 1;

FIG. 6 is a schematic section view of the planting pot of FIG. 1, in use with soil, water and a plant;

FIG. 7 is a schematic bottom perspective view of the plant watering assembly of the planting pot of FIG. 1;

FIG. 8 is a schematic front perspective view of a wick holder and wick of the plant watering assembly of FIG. 7;

FIG. 9 is a schematic bottom perspective view of a second example embodiment of a plant watering assembly of the planting pot of FIG. 1; and

FIG. 10 is a schematic front perspective view of a wick holder and wick of the plant watering assembly of FIG. 9.

### DETAILED DESCRIPTION

The present disclosure relates to a planting pot or planting pot device 100 including a planting pot or container 110 and a watering system or assembly 200 that provides water to soil S disposed in a soil retaining region 150 of the container 110 by capillary action. Advantageously, the watering assembly 200 includes a plurality of wicks 260 that are held or supported in a substantially upright or vertical orientation V within the soil S by a plurality of wick holders 240. The plurality of wick holders 240, in turn, are supported in in a substantially upright or vertical orientation V by a support pedestal 210 of the watering assembly 200. In one example embodiment, each of the plurality of wick holders 240 are removably secured within respective openings of a plurality of openings 220 of the support pedestal 210 by a bayonet connection structure 221 a between a wick holder and the corresponding opening of the support pedestal 210. Supporting the plurality of wicks 260 in the upright or vertical orientation V and partially enclosing the wicks 262. 264, 266, 268 within respective wick holders 242, 244, 246, 248 facilitates upward transport or conveyance of water by capillary action to soil S adjacent an upper surface US of the soil S near the top of the planting pot or container 110. This configuration advantageously provides water to the roots of a plant P having a shallow root system R by directing a greater volume of water in a lower water reservoir 140 of the container 110 to upper areas or regions UR of the soil S closer to the soil upper surface US.

In one example embodiment, the planting pot or planting pot device 100 includes the planting pot or container 110 and the capillary action watering assembly or capillary watering assembly 200. The container 100, one example embodiment, has a generally frustoconical or truncated cone configuration. That is, if the container were viewed in section at a horizontal midline 112 of the container 110, the midline edge or periphery, in top plan view, would be substantially circular. It should be understood, of course, that the planting pot or container 110 may embody any configuration desired that would include an interior region 120 having a lower water reservoir 130 and an upper soil or growing medium retaining region 140, separated by a support pedestal 210 of the watering assembly 200. For example, in top plan view, the container 110 of the present disclosure may be circular, triangular, square, rectangular, or any polygonal shape. In one example embodiment, the pot or container 110 is fabricated of a durable resin material that can withstand soil, water, fertilizer and the like. Alternately, the pot or container 110 and the watering assembly 200 may be fabricated from other suitable durable material or materials that can withstand soil, water, fertilizer and the like.

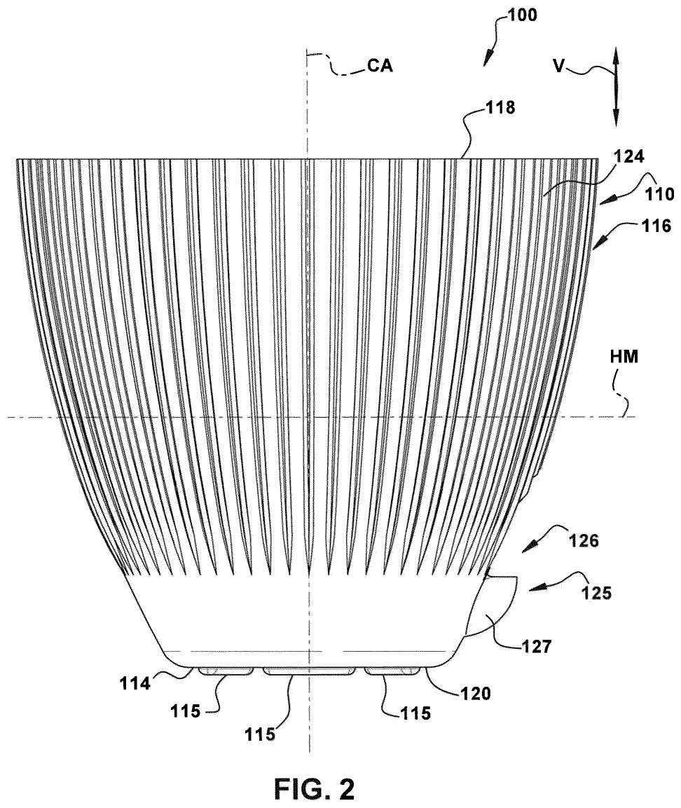

In one example embodiment, as best seen in FIG. 2, when viewed along a central vertical axis CA, the planting pot or container 100 includes a base 114 and a generally tapered, vertical side wall or wall 116 extending upwardly from the base 114. The base 114 and the wall 116 define an interior region 130 of the planting pot 100 which includes the lower water reservoir 140 and an upper soil retaining region 150 separated by the support pedestal 210. The wall 116 is tapered from a larger diameter upper end 118 to a smaller diameter lower end 120. The base 114 is generally planar and includes a plurality of downwardly projecting extensions or nubs 115 that contact a surface that the container 110 is resting on. The wall 116 includes an inner surface or wall 122 facing the interior region 130 and an outer surface or wall 124 facing away from the interior region 130. To allow for the addition of water W to the water reservoir 140 from an exterior of the container 110, the side wall 116 includes a side opening or port 125 extending through the side wall 116. The side port 125 defines an opening 126 allows a user to fill a lower portion of the interior region 130, that is, to fill the water reservoir 140 of the pot 110 with water. In one example embodiment, the side port 125 includes a radially outwardly extending funnel 127 to direct water poured into the funnel 127 into the water reservoir 140 of the container 110.

The port 125 further includes a radially inwardly extending projection 128 that interfits with an arcuate peripheral or edge cut-out region 218 of a body 212 of the support pedestal 210 to orient and maintain the position of the support pedestal 210 within the interior region 130 of the container 110. That is, extending radially inwardly from the inner wall 122, the port 125 advantageously includes the projection 128. Viewed in top plan view, the projection 128 is arcuate. Advantageously, the projection 128 is sized and configured to be received in the peripheral or edge cut-out 218 of the disk-shaped body 212 of the support pedestal 210 so as to properly align the support pedestal 210 as it fits within the inner wall 122 of the side wall 116. Additionally, proper alignment and support of the support pedestal 210 within the interior region 130 of the planting pot 100 is further provided by a downwardly extending boss 230 of the support pedestal 210 which bears against the base 114 of the container 110. As the soil (or other planting medium) S is disposed above the support pedestal 210, the support pedestal 210 necessarily carries a portion of the weight of the soil S. Thus, it is important that the support pedestal 210 be able to sustain the soil weight. The provision of the downwardly or axially extending boss 230 which bears against the base 114 of the container 110 and enhances the ability of the support pedestal 210 to bear the soil weight and maintain proper alignment of the support pedestal 210 within the planting pot interior region 130. Additionally, the downwardly extending boss 230 maintains the support pedestal 210 at a desired height above the water reservoir 140. The downwardly extending boss 230 is largely disposed in the water reservoir 140 and therefore includes a plurality of holes 234 and a plurality of slits 235 to allow the communication of water through the plurality of holes and slits 234, 235.

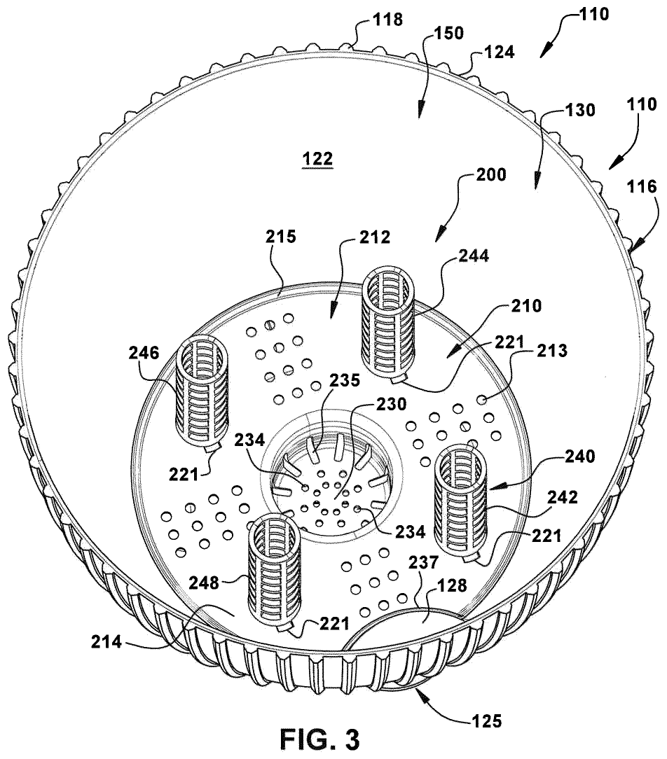

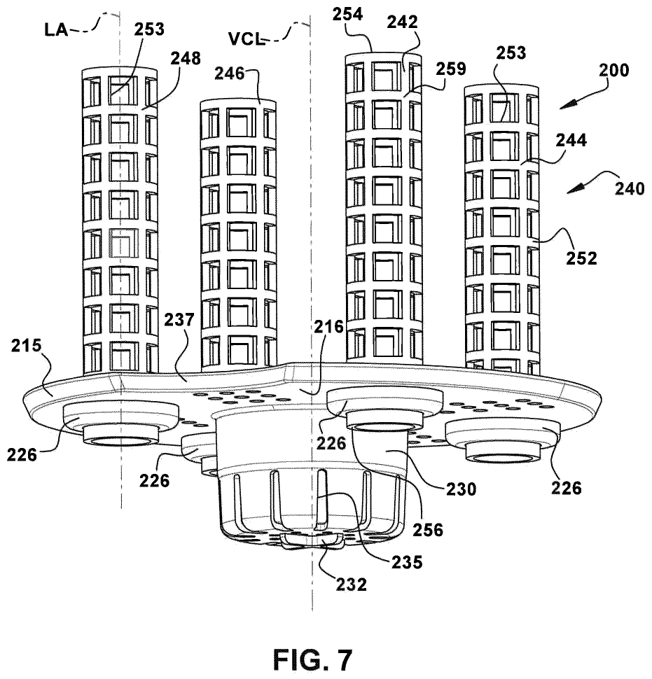

As best seen in FIGS. 3 and 7, an outer periphery of the upper side 214 of the disk-shaped body 212 advantageously includes an upwardly extending lip 215 which bears against the inner wall 122 of the container 110 and thereby provides further stability to the support pedestal 210 within the interior region 130 of the container 110 and advantageously inhibits undesired egress or leakage of soil S from the upper soil retaining region 150 along the inner wall 122 into the lower water reservoir 140. Similarly, the upper side 214 of the body 212 in the region of the peripheral or edge cut-out 218 of the disk-shaped body 212 includes an upwardly extending lip 219 that bears against the projection 128 of the side port 125 to enhance the stability of the support pedestal 210 within container interior region 130 and advantageously inhibits undesired egress or leakage of soil S from the upper soil retaining region 150 along the inner wall 122 into the lower water reservoir 140. The disk-shaped body 212 includes a plurality of holes 213 extending through the upper and lower sides 214, 216 of the body 212 that provide for drainage of excess water from the soil S in the soil retaining region 150 to the water reservoir 140.

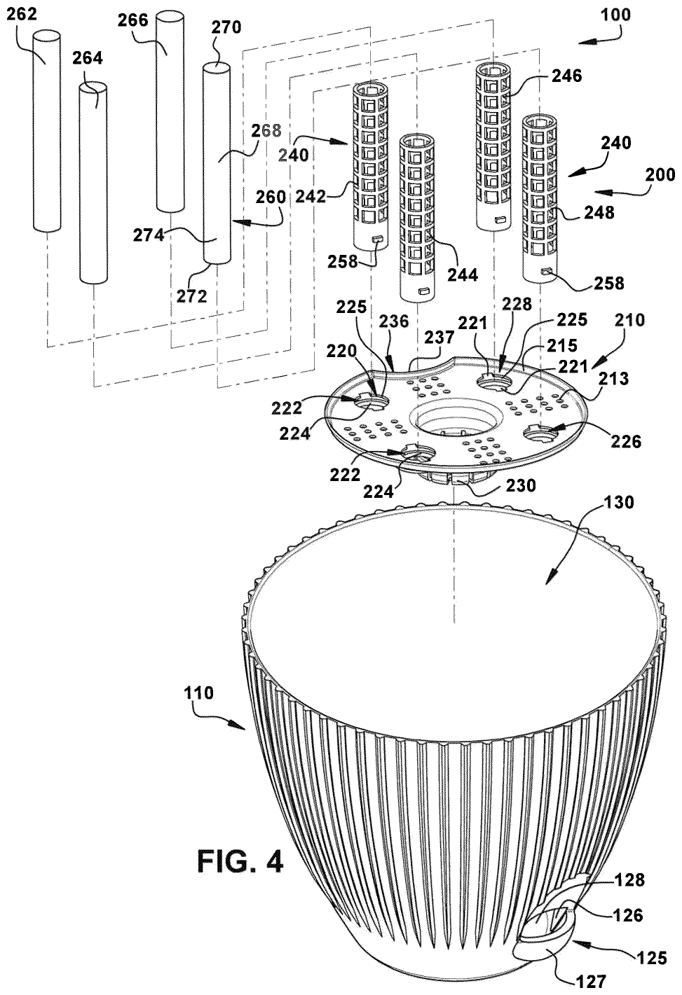

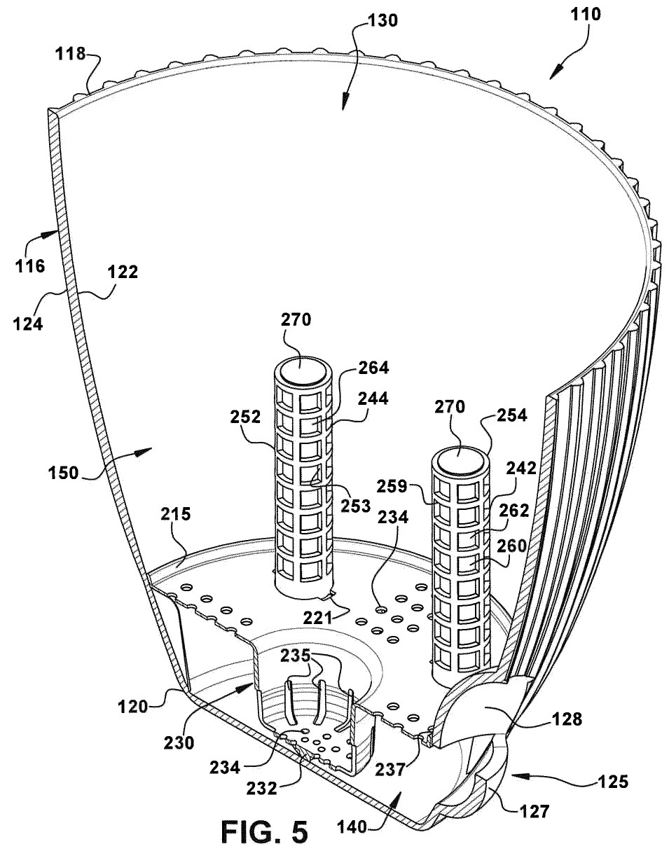

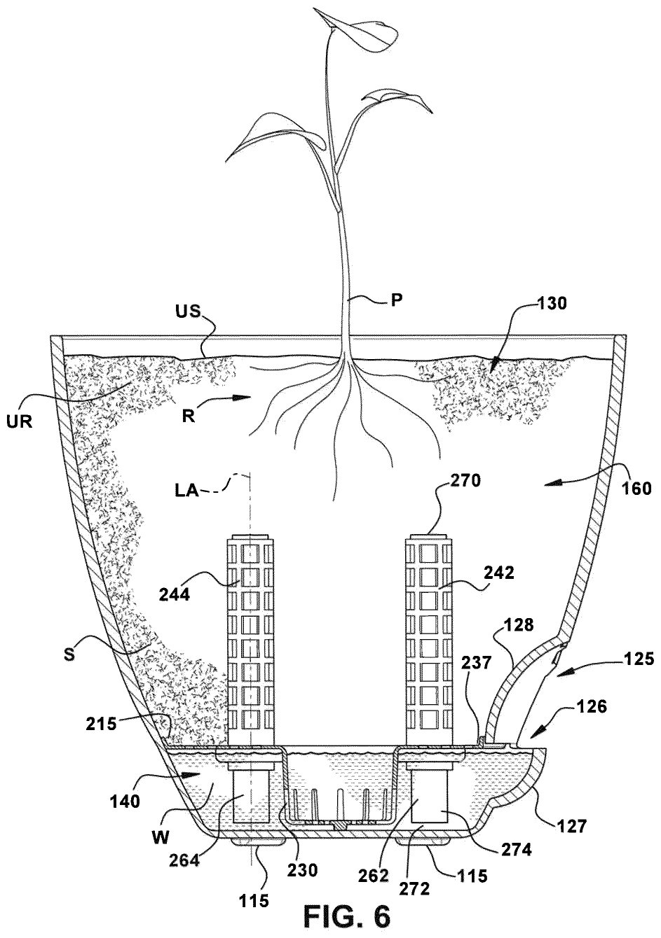

The capillary watering action is provided by the capillary watering assembly 200. In a first example embodiment, as depicted in, for example, FIGS. 3-7, the capillary watering assembly 200 includes the support pedestal 210, the plurality of wick holders 240, and the corresponding plurality of wicks 260, each of which is supported in one of the plurality of wick holders 240. The support pedestal 210 includes the disk-shaped body 212, including an upper side 214 and a spaced apart lower side 216. A plurality of through bores or openings 220 extend axially between and through the upper and lower sides 212, 214 of the body 212. In one example embodiment, there are four through bores or openings 222, 224, 226, 228 of the support pedestal body 212 that are uniformly circumferentially spaced about a vertical center line VCL of the body 212. The through bores or openings 222, 224, 226, 228 extend axially or vertically through the support pedestal body 212 and, more specifically, in one example embodiment, the openings 222, 224, 226, 228 extend through collars 226 protruding from lower side 216 of body 212. The collars 226 provide additional support and strength to firmly secure the wick holders 242, 244, 246, 248 in the upright or vertical orientation V. That is, the plurality of wick holders 240, that is, wick holders 242, 244, 246, 248, are received into and supported by interior walls 224 of the collars 226, of the respective opening 222, 224, 226, 228, of the plurality of openings 220 of the body 212 of the support pedestal 210. Similarly, wicks 262, 264, 266, 268 of the plurality of wicks 260 are supported and held within respective wick holders 242, 244, 246, 248 of the plurality of wick holders 240. Additionally, as mentioned previously, the support pedestal 210 also includes the boss 230 which extends downwardly from the lower side 214 of the body 212 and bears against the base 114 of the container 110. In one example embodiment, a downwardly extending central ridge 232 of the boss 230 contacts and bears against the base 114 of the container 110.

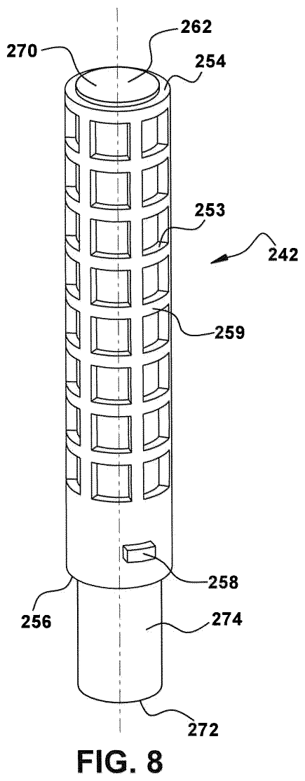

In one example embodiment, each of the four wick holders 242, 244, 246, 248 of the plurality of wick holders 240 are generally cylindrical, for example, a cylindrical casing defining a central, longitudinally extending opening or through bore, extending along a longitudinal axis LA between an upper end 254 and a lower end 256 and having a base portion 250 and an upright portion 252 extending upwardly from the base portion 250 and substantially centered about the wick holder longitudinal axis LA. As best seen in FIG. 8, a respective wick, for example, representative wick 262, is received in the through bore of the casing of the associated wick holder, for example, representative wick holder 242. Looking at the representative wick holder 242, in exemplary embodiment, the upright portion 252 of the wick holder 242 includes a plurality or an array of spaced apart generally rectangular openings 254 allowing for the egress of water from the wick, for example, wick 262, supported by the wick holder 242, into the soil S adjacent the wick holder 242. In one example embodiment, the number of rectangular openings in the array of rectangular openings 253 of the wick holder 242 is eight in vertical extent and five in circumferential extent for a total of 40 openings. The lower or base portion 250 functions as the interface or connection with the corresponding opening 222 of the disk-shaped body 212 of the support pedestal 210. In one example embodiment, the connection structure between the base portion 250 of the wick holder 242 and the opening 222 of the support pedestal disk-shaped body 212 is the bayonet connection 221a. Specifically, a pair of radially extending tabs 258 of the base portion 250 are configured to fit into a pair of apertures 221 in the upper side 214 of the disk-shaped body 212. The interior wall 224 of the collar 226 defining the opening 222 includes respective short threaded regions 225 extending from the pair of apertures 221. Upon insertion of the pair of tabs 258 into the pair of apertures 221, the wick holder 242 is rotated thereby threading the pair of tabs 258 of the lower portion 250 of the wick holder 242 into respective threaded regions of the interior wall 224 of the collar 226 to secure the bayonet connection 221a between the wick holder 242 and the opening 222 of the disk-shaped body 212 of the support pedestal 210 to secure the wick holder 242 (and the wick 262 supported by the wick holder 242) to the support pedestal 210 in the desired vertical orientation V.

In one example embodiment, an upper end 270 of the wick 262 is substantially even or level with the upper end 254 of the wick holder 242, while a lower end 272 of the wick 262 extends below the lower end 256 of the wick holder 242 and below the collar 226 extending below the lower side 216 of the support pedestal body 212. Specifically, a lower or bottom portion 274 of the wick 262 extends downwardly so that the wick 262 is immersed in the water W of the water reservoir 140, even if the level of water W in the water reservoir is significantly less than full capacity.

The bottom portion 274 of the wick 262 extends into the water reservoir 140 and the upper portion or end 270 of the wick 262 is generally flush with the upper end 254 of the wick holder 242. By capillary action, each wick 262, 264, 266, 268 of the plurality of wicks 260 transfers water from the water reservoir 140 upwardly and radially outwardly through the array of wick holder openings 253 and into the soil S, thereby providing an acceptable moisture content throughout the various levels of the soil S. Depending on the configuration of the planting pot 100, the upper end 254 of the wick holder 242 is a predetermined distance below the upper surface US of the soil S. In this way, by the capillary action of the plurality of wicks (J), sufficient moisture is transferred to the soil adjacent the roots of the plant P, even if the plant P has shallow roots R, thereby overcoming the deficiencies of the prior art. Advantageously, because the wicks 262, 264, 266, 268 of the plurality of wicks 260 are disposed with the respective wick holders 242, 244, 246.248 of the plurality of wick holders 240, the plurality of wicks 260 are advantageously maintained in a vertical orientation V in the soil S. Thus, the respective upper ends 270 of each of the plurality of wicks 260 are maintained at the desired, predetermined distance below the upper surface US of the soil S, as opposed to being folded over, angled or otherwise ending up with upper ends 270 lower in the soil S than desired.

Further and advantageously, since the wick holders 242m 244, 246, 248 of the plurality of wick holders 240 have an array of openings 253, the area of contact between a given wick, for example, the wick 262 and the soil S is limited to an amount that is necessarily less than the total outer surface area of the wick 262. The limited contact area afforded by the plurality of wick holders 240 of the present disclosure addresses the prior art problem of having too large an area of direct contact between the wick 262 and the soil S. That is, too great an area of direct contact between the wick 262 and the soil S may reduce the effective upward capillary force of the wick 262 such that the upwardly transported water in the wick 262 tends to leach out of the wick 262 at too low a level or region in the soil S in the planning pot 100. Such a situation may result in too low a level of hydration in the upper regions UR of the soil S which would be detrimental to a plant P having a shallow root system R. That is, it may be the case that while the soil S nearer the water reservoir 140 is moist, however the soil S near the top US of the planting pot 100 is much drier. The planting pot device 100 of the present disclosure successfully addresses both of the foregoing issues.

### Second Example Embodiment—Capillary Plant Watering Assembly 1200

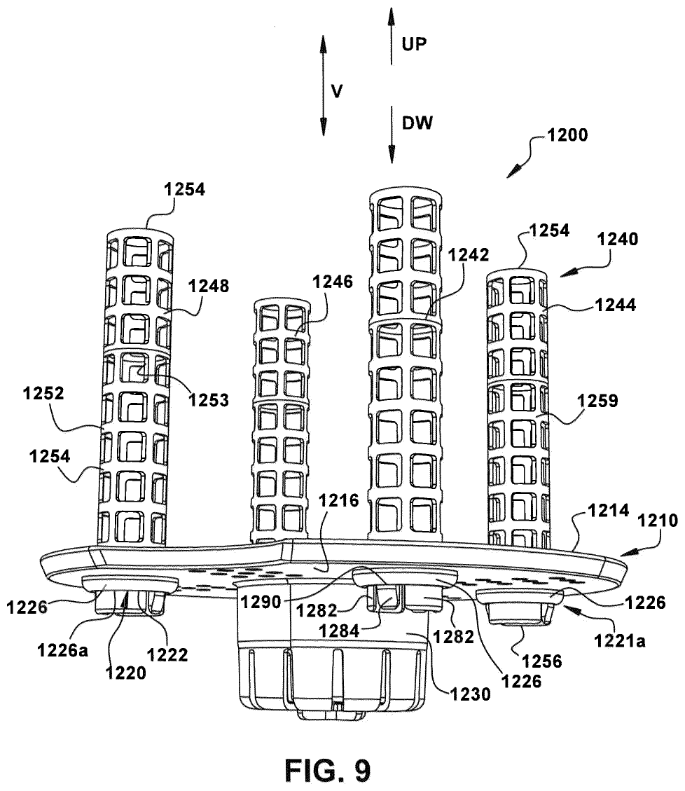

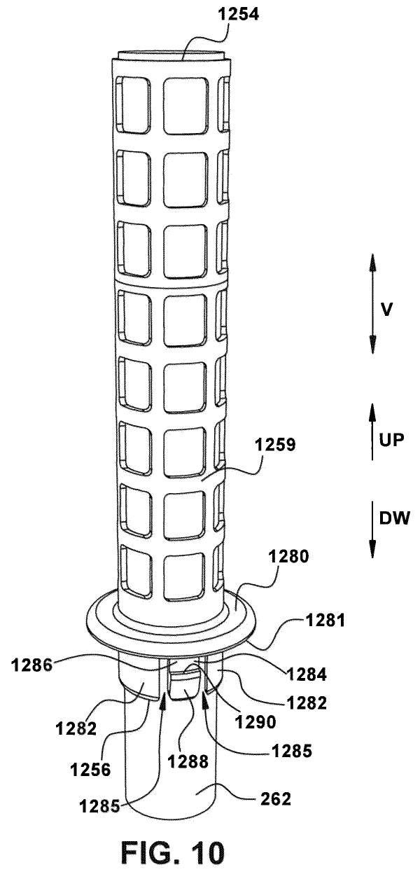

A second example embodiment of a capillary plant watering assembly 1200 of the present disclosure is schematically depicted in FIGS. 9 and 10. The plant watering assembly 1200 including a support pedestal 1210 and a plurality of wick holders 1240. The wicks utilized with the plurality of wick holders 1240 remain the same in function and configuration as the plurality of wicks 260. One representative wick 262 is depicted supported by wick holder 1242 in FIG. 10. For clarity, the plurality of wicks 260 are not depicted in FIG. 10. For brevity, parts of the support pedestal 1210 and the plurality of wick holders 1240 that are substantially similar in configuration and function to the support pedestal 210 and the plurality of wick holders 240 of the plant watering system 200 of the first example embodiment, will not be described in detail, reference being made to the previous discussion. In the plant watering assembly 200 of the first example embodiment, a bayonet connection structure 221a is utilized to removably secure the plurality of wick holders 240 in a vertical orientation V within respective openings of the plurality of openings 220 of the support pedestal 210. In the plant watering assembly 1200 of the second example embodiment, a snap fit connection structure 1221a is utilized to removably secure the plurality of wick holders 1240 in a vertical orientation V within respective openings of the plurality of openings 1220 if the support pedestal 1210.

The support pedestal 1210 of the plant watering assembly 1200 includes a disk-shaped body 1212 including generally planar upper and lower surfaces or side 1214, 1216. The body 1212 includes a plurality of openings 1220. Each opening, for example, opening 1222 of the plurality of openings 1220 includes a collar 1226 extending from the lower side 1216 of the body 1212, which defines part of the generally cylindrically shaped opening. In one example, embodiment, the number of openings in the plurality of openings 1220 is four and, accordingly, the number of wick holders of the plurality of wick holders 1240 is also four. The support pedestal 1210 includes a central downwardly extending boss 1230.

The plurality of wick holders 1240, including wick holders 1242, 1244, 1246, 1248, each comprise a casing defining a central, longitudinally extending through bore and including a base portion 1250 which interfits into respective openings of the plurality of openings 1220, and an upright portion 1252 which extends above, the upper surface 1214 of the support pedestal body 1212. Each wick holder of the plurality of wick holders 1240 includes an array of openings 1253 and extends between an upper end 1254 and a lower end 1256. In one example embodiment, the base portion 1250 includes a radially outwardly protruding flange 1280 extending from an outer wall 1259 of the wick holder, for example, representative wick holder 1242 (FIG. 10) of the plurality of wick holders 1240. The flange 1280 includes a generally planar lower surface 1281 which serves as a bearing surface, bearing against the upper surface or side 1214 of the support pedestal body 1212. The base portion 1250 of the wick holder 1242 includes a circumferentially spaced apart pair of downward extending arcuate wall portions 1282 that extend from the planar lower surface 1261 and continue the inner diameter or opening of the upright portion 1252 and the inner diameter or opening of the flange 1280, that is, define part of the central through bore of the wick holder 1242. Spaced circumferentially between the pair of arcuate wall portions 1282 are a pair of downwardly extending flexing wall portions 1284. The pair of flexing wall portions 1284 are circumferentially spaced from the adjacent pair of arcuate wall portions 1282 by gaps 1285.

Each of the pair of flexing wall portions 1284 include a tab 1288 extending outwardly from outer surface 1286 of the flexing wall portion. When the wick holder 1242 is pushed through the corresponding opening 1222 of the support pedestal body 1212 from the upper side 1214 of the body 1212, the pair of flex wall portions 1284 are compressed radially inwardly, thereby allowing the base portion 1250 to pass through the opening 1222. Downward movement of the wick holder 1242 in the direction DW (FIG. 10) continues until such time as the lower surface 1281 of the flange 1280 of the base portion 1250 seats against the upper side 1214 of the support pedestal body 1212. The longitudinal spacing between the lower surface 1281 and the pair of tabs 1288 of the flexing wall portions 1284 is such that when the lower surface 1281 of the flange 1280 of the base portion 1250 seats against the upper side 1214 of the support pedestal body 1212, the pair of tabs 1288 pass through the collar 1226 extending from the lower side 1216 of the body 1212.

Upon passing through the collar 1226, the pair of flex wall portions 1284 spring outwardly and respective bearing surfaces 1290 of the pair of tabs 1288 bear against a lower surface 1226a of the collar 1226 thereby securing the wick holder 1242 in the opening 1222 of the support pedestal body 1212. This constitutes the snap-fit connection 1221a. Advantageously, the wick holder 1242 is precluded from axial movement (movement in the direction V) within the opening 1222 of the support pedestal body 1212 by two bearing interfaces: a) bearing between the lower surface 1281 of the flange 1280 of the base portion 1250 and the upper side 1214 of the support pedestal body 1212 prevents downward movement DW of the wick holder 1242 with respect to the support pedestal 1210; and b) bearing between respective bearing surfaces 1290 of the pair of tabs 1288 and the lower surface 1226a of the collar 1226 thereby securing the wick holder 1242 in the opening 1222 of the support pedestal body 1212 prevents upward movement UP of the wick holder 1242 with respect to the support pedestal 1210.

As used herein, terms of orientation and/or direction such as upward, downward, forward, rearward, upper, lower, inward, outward, inwardly, outwardly, horizontal, horizontally, vertical, vertically, distal, proximal, axially, radially, etc., are provided for convenience purposes and relate generally to the orientation shown in the Figures and/or discussed in the Detailed Description. Such orientation/direction terms are not intended to limit the scope of the present disclosure, this application and the invention or inventions described therein, or the claims appended hereto.

What have been described above are examples of the present disclosure/invention. It is, of course, not possible to describe every conceivable combination of components, assemblies, or methodologies for purposes of describing the present disclosure/invention, but one of ordinary skill in the art will recognize that many further combinations and permutations of the present disclosure invention are possible. Accordingly, the present disclosure invention is intended to embrace all such alterations, modifications, and variations that fall within the spirit and scope of the appended claims.

1. A planting pot comprising:
a) a container including a base and a wall extending upwardly from the base, the base and wall defining an interior region of the planting pot; and
b) a plant watering assembly including:
1) a support pedestal disposed within the interior region of the planting pot, the support pedestal dividing the interior region of the planting pot into a lower water reservoir and an upper soil retaining region, the support pedestal including a body having a circumferential rim engaging an inner surface of the wall of the container and father including a central boss extending down pedestal body and contacting the base of the planting pot container, a side wall of the central boss centered about a vertical center line of body, the body of the support pedestal further including a plurality of openings;
2) a plurality of wick holders, each wick bolder of the plurality of wick holders defining a central through bore and including a base portion received in an opening of the plurality of openings of the body of the support pedestal and an upwardly extending projection that extends into the upper soil retaining region of the planting pot, the upwardly extending projection including a plurality of orifices; and
3) a plurality of water transferring wicks, each wick of the plurality of water transferring wicks received in the central through bore of a respective one of the plurality of wick holders, a lower end portion of each of the plurality of water transferring wicks extending into the lower water reservoir of the planting pot and an upper end portion of each of the plurality of water transferring wick extending into the upper soil retaining region of the planting pot, the plurality of orifices of each wick holder of the plurality of wick holders permitting water flow from the respective wicks of the plurality of water transferring wicks into the upper soil retaining region of the planting pot.

2. The planting pot of claim 1 wherein each wick holder of the plurality of wick holders is cylindrical.

3. The planting pot of claim 1 wherein the body of the support pedestal is a disk-shaped body.

4. The planting pot of claim 1 wherein the central boss of the support pedestal includes a downwardly extending central ridge which contacts the base of the planting pot container.

5. The planting pot of claim 1 wherein the wall of the container includes a side port in fluid communication with the lower water reservoir of the planting pot.

6. The planting pot of claim 5 wherein the side port includes an inwardly extending projection that extends into the interior region of the planting pot.

7. The planting pot of claim 6 wherein the circumferential rim of the body of the support pedestal includes a recess that interfits with the inwardly extending projection of the side port of the wall of the container.

8. The planting pot of claim 1 wherein the container is frustoconical in shape.

9. The planting pot of claim 1 wherein the container is circular in horizontal cross section.

10. A planting pot device comprising:
a) a planting pot including a base and a wall extending upwardly from the base, the base and wall defining an interior region of the planting pot; and
b) a plant watering assembly including:
1) a support pedestal disposed within the interior region of the planting pot, the support pedestal dividing the interior region into a lower water reservoir and an upper soil retaining region, the support pedestal including a body having a circumferential rim engaging the wall of the planting pot further including a central boss extending downwardly from the support pedestal body and contacting the base of the planting pot, the body of the support pedestal further including a plurality of openings;
2) a plurality of wick holders, each wick holder of the plurality of wick holders having a central through bore and including a base portion received in an opening of the plurality of openings of the body of the support pedestal and an upwardly extending projection that extends into the upper soil retaining region of the planting pot; and
3) a plurality of water transferring wicks, each wick of the plurality of water transferring wicks received in the central through bore of a respective one of the plurality of wick holders, a lower end portion of each of the plurality of water transferring wicks extending into the lower water reservoir of the planting pot and an upper end portion of each of the plurality of water transferring wicks extending into the upper soil retaining region of the planting pot.

11. The planting pot device of claim 10 wherein each wick holder of the plurality of wick holders is cylindrical.

12. The planting pot device of claim 10 wherein the body of the support pedestal is a disk-shaped body.

13. The planting pot device of claim 10 wherein the central boss of the support pedestal includes a downwardly extending central ridge which contacts the base of the planting pot.

14. The planting pot device of claim 10 wherein the wall of the container includes a side port in fluid communication with the lower water reservoir of the planting pot.

15. The planting pot device of claim 14 wherein the side port includes an inwardly extending projection that extends into the interior region of the planting pot.

16. The planting pot device of claim 15 wherein the circumferential rim of the body of the support pedestal includes a recess that interfits with the inwardly extending projection of the side port of the wall of the planting pot.

17. The planting pot device of claim 10 wherein the container is frustoconical in shape.

18. The planting pot device of claim 10 wherein the container is circular in horizontal cross section.

19. The planting pot device of claim 10 wherein the wall of the planting pot includes an inner wall and an outer wall, the circumferential rim of the support pedestal body engaging the inner wall of the planting pot.

20. The planting pot devices of claim 10 wherein for each wick holder of the plurality of wick holders, the upwardly extending projection includes a plurality of orifices along a longitudinal extent of the projection, the plurality of orifices of the wick holder permitting water flow from the each wick of the plurality of wicks into the upper soil retaining region of the planting pot.
